(19) United States
(12) Patent Application Publication
(10) Pub. No.: US 2024/0373191 A1
(43) Pub. Date: Nov. 7, 2024

(54) DATA PROCESSING APPARATUS AND METHOD

(71) Applicant: Sony Interactive Entertainment Inc., Tokyo (JP)

(72) Inventors: Lawrence Martin Green, London (GB); Maria Chiara Monti, London (GB)

(73) Assignee: Sony Interactive Entertainment Inc., Tokyo (JP)

(21) Appl. No.: 18/645,503

(22) Filed: Apr. 25, 2024

(30) Foreign Application Priority Data
May 5, 2023 (GB) 2306666.5

(51) Int. Cl. H04W 4/02; G06F 3/01; H04W 4/80; H04W 8/00

(52) U.S. Cl. CPC H04W 4/023; G06F 3/011; H04W 4/80; H04W 8/005

(57) ABSTRACT

A data processing apparatus includes circuitry configured to: initiate output of audio and/or visual content; determine, based on one or more first short-range wireless discovery signals received from each of one or more other apparatuses in a vicinity of the data processing apparatus when output of the content is initiated, an identity of each of the one or more other apparatuses; and determine, based on one or more second short-range wireless discovery signals received from each of the one or more other apparatuses, whether any of the one or more other apparatuses are no longer in the vicinity of the data processing apparatus; and when any of the one or more other apparatuses are no longer in the vicinity of the data processing apparatus, pause output of the content.

### BACKGROUND

### Field of the Disclosure

This disclosure relates to a data processing apparatus and method.

### Description of the Related Art

The “background” description provided is for the purpose of generally presenting the context of the disclosure. Work of the presently named inventors, to the extent it is described in the background section, as well as aspects of the description which may not otherwise qualify as prior art at the time of filing, are neither expressly or impliedly admitted as prior art against the present disclosure.

It is sometimes desirable for users to pause the output of content such as videos or video games. This is conventionally done by manually selecting a “pause” function (e.g. via a pause button) using a controller (e.g. television remote controller, gaming controller or the like) to firstly pause output of the content and then, when appropriate, resume output of the content.

However, the need to manually pause and resume content in this way can be cumbersome, especially when there is more than one user viewing the content and one of the users wishes to pause the content. For example, when watching video content with several users, if a user wishes for the content to be paused while they temporarily leave the room and they are not a user with a controller for manually selecting the pause function, they will need to verbally ask another user with a controller to implement the pause function. This delays the pausing and also risks audio content of the video being missed due to the user needing to speak over the content. There may also be a delay to pausing due to the need to physically find a controller and/or obtain it if is not already in the vicinity of the user(s).

There is therefore a desire for a better way of controlling pausing and resuming of content.

### SUMMARY

The present disclosure is defined by the claims.

### BRIEF DESCRIPTION OF THE DRAWINGS

Non-limiting embodiments and advantages of the present disclosure are explained with reference to the following detailed description taken in conjunction with the accompanying drawings, wherein:

FIG. 1 schematically shows an example entertainment system;

FIGS. 2A and 2B schematically show example components associated with the entertainment system;

FIG. 3A schematically shows an example screen for enabling automatic content pausing;

FIG. 3B schematically shows an example lookup table;

FIG. 4 schematically shows initiation of content output when all devices in the lookup table are detectable;

FIG. 5A schematically shows automatic pausing of content output when a device in the lookup table is no longer detectable;

FIG. 5B schematically shows deletion of the non-detectable device from the lookup table following manual intervention by a user;

FIG. 5C schematically shows automatic resumption of content output when the non-detectable device becomes detectable again; and

FIG. 6 shows an example method.

Like reference numerals designate identical or corresponding parts throughout the drawings.

### DETAILED DESCRIPTION OF THE EMBODIMENTS

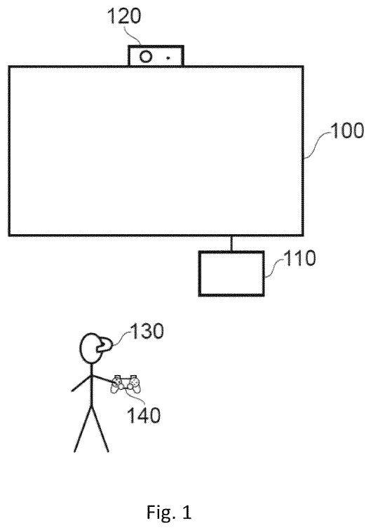

FIG. 1 schematically illustrates an entertainment system suitable for implementing one or more of the embodiments of the present disclosure. Any suitable combination of devices and peripherals may be used to implement embodiments of the present disclosure, rather than being limited only to the configuration shown.

A display device 100 (e.g. a television or monitor), associated with a games console 110, is used to display content to one or more users. A user is someone who interacts with the displayed content, such as a player of a game, or, at least, someone who views the displayed content. A user who views the displayed content without interacting with it may be referred to as a viewer. This content may be a video game, for example, or any other content such as a movie or any other video content. The games console 110 is an example of a content providing device or entertainment device; alternative, or additional, devices may include computers, mobile phones, set-top boxes, and physical media playback devices, for example. In some embodiments the content may be obtained by the display device itself—for instance, via a network connection or a local hard drive.

One or more video and/or audio capture devices (such as the integrated camera and microphone 120) may be provided to capture images and/or audio in the environment of the display device. While shown as a separate unit in FIG. 1, it is considered that such devices may be integrated within one or more other units (such as the display device 100 or the games console 110 in FIG. 1).

In some implementations, an additional or alternative display device such as a head-mountable display (HMD) 130 may be provided. Such a display can be worn on the head of a user, and is operable to provide augmented reality or virtual reality content to a user via a near-eye display screen. A user may be further provided with a video game controller 140 which enables the user to interact with the games console 110. This may be through the provision of buttons, motion sensors, cameras, microphones, and/or any other suitable method of detecting an input from or action by a user.

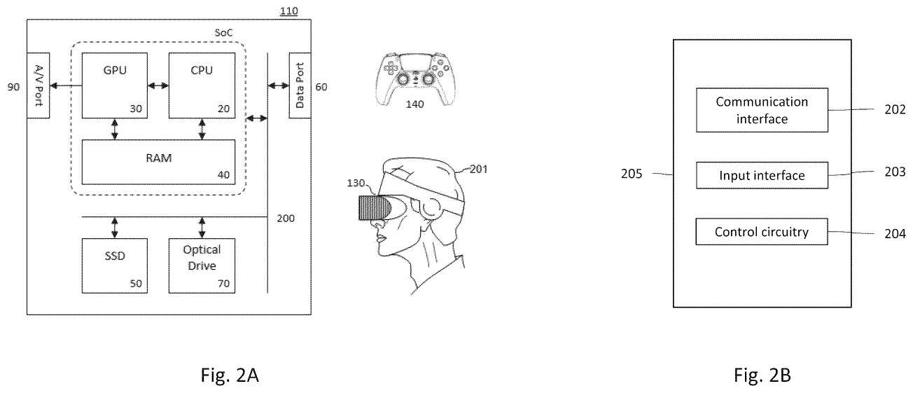

FIG. 2A shows an example of the games console 110. An example is the Sony® PlayStation 5® (PS5). The games console 110 is an example of a data processing apparatus.

The games console 110 comprises a central processing unit or CPU 20. This may be a single or multi core processor, for example comprising eight cores as in the PS5. The games console also comprises a graphical processing unit or GPU 30. The GPU can be physically separate to the CPU, or integrated with the CPU as a system on a chip (SoC) as in the PS5.

The games console also comprises random access memory, RAM 40, and may either have separate RAM for each of the CPU and GPU, or shared RAM as in the PS5. The or each RAM can be physically separate, or integrated as part of an SoC as in the PS5. Further storage is provided by a disk 50, either as an external or internal hard drive, or as an external solid state drive (SSD), or an internal SSD as in the PS5.

The games console may transmit or receive data via one or more data ports 60, such as a universal serial bus (USB) port, Ethernet® port, WiFi® port, Bluetooth® port or similar, as appropriate. It may also optionally receive data via an optical drive 70.

Interaction with the games console is typically provided using one or more instances of the controller 140, such as the DualSense® handheld controller in the case of the PS5. In an example, communication between each controller 140 and the games console 110 occurs via the data port(s) 60.

Audio/visual (A/V) outputs from the games console are typically provided through one or more A/V ports 90, or through one or more of the wired or wireless data ports 60. The A/V port(s) 90 may also receive audio/visual signals output by the integrated camera and microphone 120, for example. The microphone is optional and/or may be separate to the camera. Thus, the integrated camera and microphone 120 may instead be a camera only. The camera may capture still and/or video images.

Where components are not integrated, they may be connected as appropriate either by a dedicated data link or via a bus 200.

As explained, examples of a device for displaying images output by the game console 110 are the display device 100 and the HMD 130. The HMD is worn by a user 201. In an example, communication between the display device 100 and the games console 110 occurs via the A/V port(s) 90 and communication between the HMD 130 and the games console 110 occurs via the data port(s) 60.

The controller 140 is an example of a peripheral device for allowing the games console 110 to receive input from and/or provide output to the user. Examples of other peripheral devices include wearable devices (such as smartwatches, fitness trackers and the like), microphones (for receiving speech input from the user) and headphones (for outputting audible sounds to the user).

FIG. 2B shows some example components of a peripheral device 205 for receiving input from a user. The peripheral device comprises a communication interface 202 for transmitting wireless signals to and/or receiving wireless signals from the games console 110 (e.g. via data port(s) 60) and an input interface 203 for receiving input from the user. The communication interface 202 and input interface 203 are controlled by control circuitry 204.

In an example, if the peripheral device 205 is a controller (like controller 140), the input interface 203 comprises buttons, joysticks and/or triggers or the like operable by the user. In another example, if the peripheral device 205 is a microphone, the input interface 203 comprises a transducer for detecting speech uttered by a user as an input. In another example, if the peripheral device 205 is a fitness tracker, the input interface 203 comprises a photoplethysmogram (PPG) sensor for detecting a heart rate of the user as an input. The input interface 203 may take any other suitable form depending on the type of input the peripheral device is configured to detect.

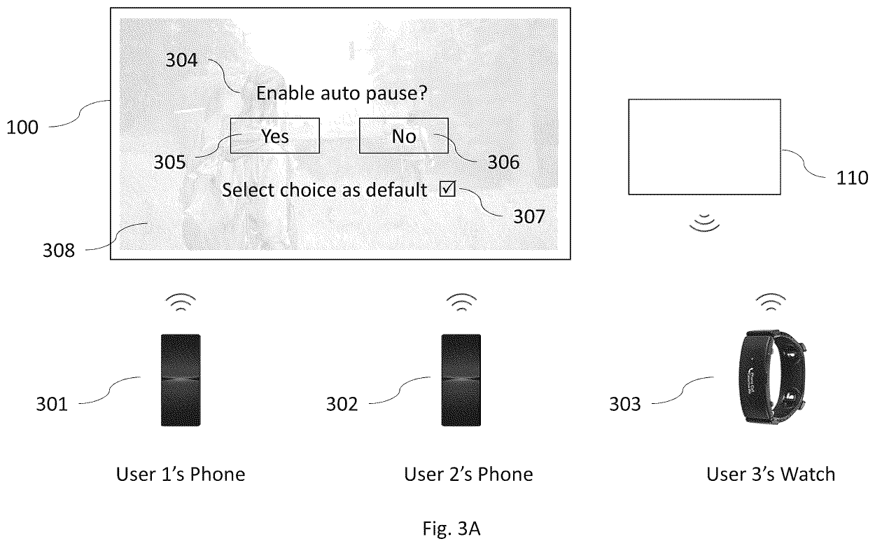

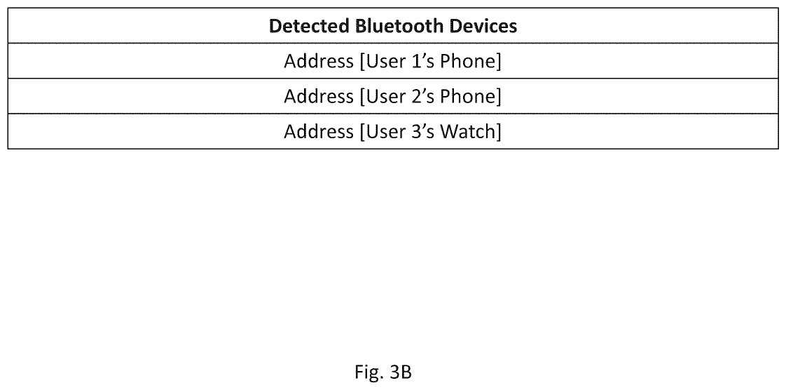

FIGS. 3A and 3B exemplify an auto pause setup according to the present technique. Here, three users (User 1, User 2 and User 3), each with respective personal devices (a smartphone 301 belonging to User 1, a smartphone 302 belonging to User 2 and a smartwatch 303 belonging to User 3) are about to view or play a video game using games console 110 and display device 100. For example, one of the users may be playing the video game and the other users may be watching the video game being played.

Before the video game begins (or, for example, in response to selection of a suitable menu item while the video game is being played), an auto pause selection screen 308 is displayed. The auto pause selection screen includes a visual message 304 asking whether auto pause should be enabled and virtual selectable buttons 305 (indicating “Yes”, auto pause should be enabled) and 306 (indicating “No”, auto pause should not be enabled). A selectable checkbox 307 is also displayed. Selection of the checkbox (as indicated by a “check” appearing in the checkbox, as shown in FIG. 3A) means that auto pause will automatically be enabled (if “Yes” is selected) or not enabled (if “No” is selected), so the screen 308 will not be shown in advance of the display of content in the future. This improves user convenience for the display of future content if their preference is to always enable auto pause or never to enable auto pause. The default choice may be changed (or the default choice cancelled, so the screen 308 is once again always displayed in advance of the display of content) using a suitable menu system or the like of the games console 110. The virtual buttons 305 and 306 and checkbox 307 are selectable using the controller 140, for example.

In this example, the user selects the “Yes” virtual button 305. This causes the devices 301, 302 and 303 to be detected by the games console 110. Display of the content then begins and the content is automatically paused if any one of the detected devices subsequently become undetectable. Thus, if a user leaves the room with their device (e.g. because their smartphone 301 or 302 is in their pocket or because they are wearing their smartwatch 303) so the device is no longer detectable, the content is automatically paused. Once the user returns to the room with their device, the device becomes detectable again and, in response to the detection, the content is resumed. This allows pausing and resuming of content to be implemented automatically when a user temporarily leaves a room without the need for manual intervention from any of the users. User convenience is therefore improved.

In an example, the detection of devices 301, 302 and 303 is implemented using Bluetooth®. When the “Yes” button 305 is selected, the games console 110 (e.g. via a Bluetooth transceiver (not shown) incorporated in data port(s) 60) transmits one or more Bluetooth inquiry signals. A Bluetooth inquiry signal is a known type of Bluetooth signal transmitted by a “master” Bluetooth device (in this case, games console 110) to ascertain other discoverable “slave” Bluetooth devices (in this case, devices 301, 302 and 303). Each of the devices 301, 302 and 303 is assumed to be in a Bluetooth inquiry scan state. This allows them to detect the Bluetooth inquiry signal(s) and, in response, transmit a response in the form of one or more Bluetooth Frequency Hopping Synchronization, FHS, packets. Each FHS packet transmitted by each of the devices 301, 302 and 303 includes a unique Bluetooth address associated with that device. This allows the games console 110 to determine the devices in range and to record them in an auto pause lookup table (data indicative of the lookup table being stored in RAM 40 or disk 50, for example). An example lookup table is shown in FIG. 3B. The lookup table includes the Bluetooth address of each of devices 301, 302 and 303.

The auto pause lookup table is populated with the address of every device which transmits FHS packet(s) to the games console within a first predetermined time period (e.g. 5 or 10 seconds) after transmission of the inquiry signal(s) by the games console 110 is started (transmission of the inquiry signal(s) being started in response to selection of the “Yes” virtual button of screen 308 or, when screen 308 is not displayed because auto pause has been enabled by default, in response to the start of output of content).

In an example, the Bluetooth transceiver of the games console 110 measures a received signal strength indicator (RSSI) of the received FHS packet(s) and only adds the Bluetooth address contained in those packet(s) to the auto pause lookup table if the RSSI is above a first threshold (in particular, above the first threshold over the entire first predetermined time period). The first threshold may be −80, −70 or −60 dBm, for example. This helps ensure that only suitable devices (that is, those most likely to be in the same room as games console 110 and display device 100 with a sufficiently strong output Bluetooth signal strength) are included in the auto pause lookup table rather than, for example, other unrelated Bluetooth devices in different rooms (and/or Bluetooth devices without a sufficiently strong output Bluetooth signal strength). Such other devices may receive the inquiry signal(s) and transmit FHS packet(s) in response but, due to being in a different room (and therefore at a greater distance from the games console 110 and/or with more obstacles along the communication path), will more likely be associated with an RSSI measurable by the games console 110 which is below the first threshold. This helps prevent inappropriate pausing of the content due to, for example, movement of an unrelated Bluetooth device (e.g. a smartphone of a user other than Users 1, 2 or 3 in a different room) or the presence of a device with a weaker and/or less reliable output Bluetooth signal strength.

In an example, output of the content is started as soon as the “Yes” (or “No”) virtual button is selected. If the “Yes” virtual button is selected, the auto pause lookup table is populated concurrently with the output of the content over the first predetermined time period over which FHS packet(s) are received (and, thus, the first predetermined time period begins when output of the content is initiated). This helps reduce any delay in the output of content while also allowing auto pausing to be enabled as soon as the first predetermined time period is over. A high quality user experience is therefore maintained.

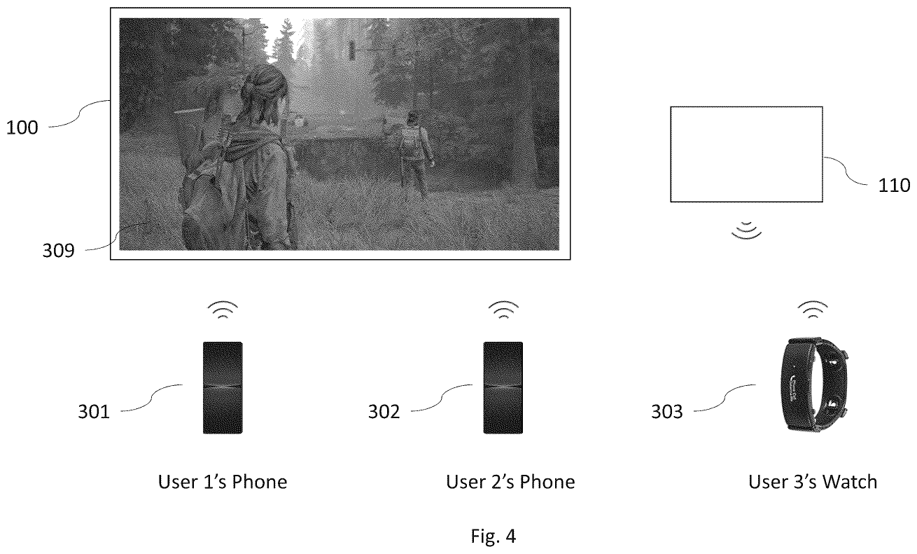

Once the auto pause lookup table has been populated, the games console 110 continues to transmit inquiry signal(s) and receive FHS packet(s) from the devices included in the lookup table as the content is output. For example, the games console 110 transmits the inquiry signal(s) periodically (e.g. every 6, 7, 8, 9 or 10 seconds). If FHS packet(s) continue to be received from each device in the lookup table and the RSSI of those FHS packet(s) continues to exceed a second threshold, then the content is not paused. This is exemplified in FIG. 4, where devices 301, 302 and 303 are all still present in the room with the games console 110 and display device 100 (thereby indicating Users 1, 2 and 3 are also still present in the room) and therefore display of the content 309 (in this case, a video game) is continued and not paused. The second threshold may be the same as the first threshold or may be different. For example, it may be lower than the first threshold (for example, the second threshold may be −80, −90 or −100 dBm) so that temporary and unintended reductions in the RSSI (e.g. due to someone walking between one of the devices 301, 302 or 303 and the games console 110 when the devices 301, 302 and 303 are still in the same room as the games console 110) are less likely to result in the content being unnecessarily paused.

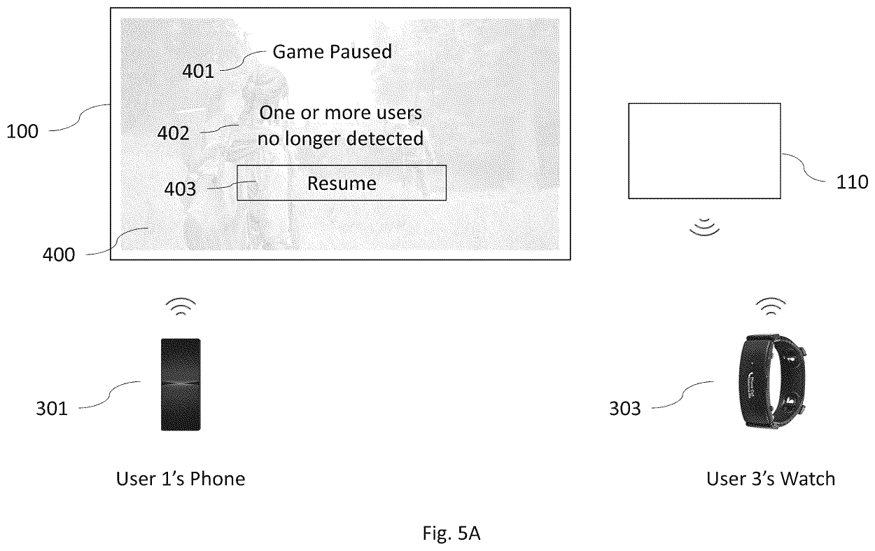

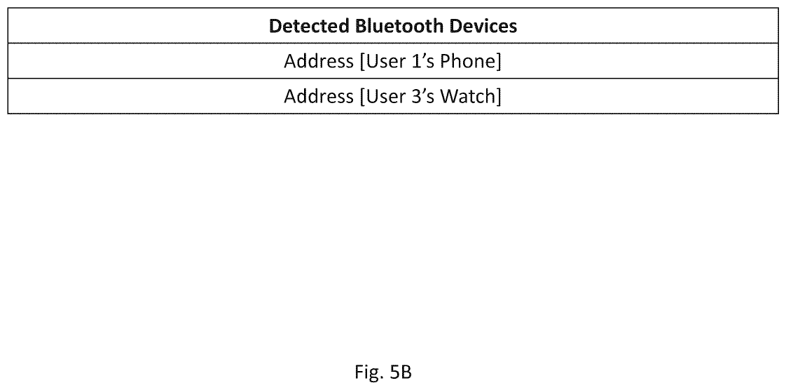

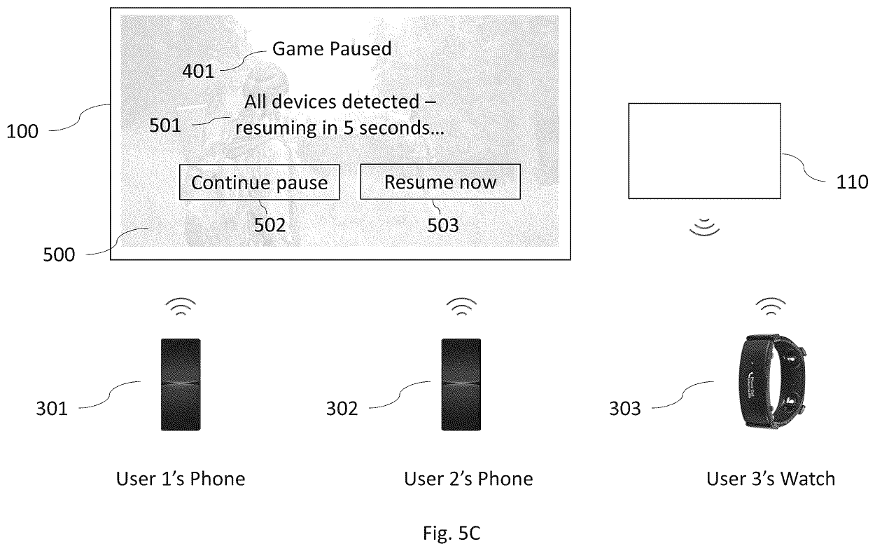

FIGS. 5A-5C show an example situation in which User 2 leaves the room while the content is being output. User 2 takes their smartphone 302 with them when they leave the room (e.g. because it is in their pocket). In response to the smartphone 302 leaving the room, the RSSI of FHS packet(s) received by the games console 110 from the smartphone 302 falls below the second threshold. This causes the games console 110 to automatically pause the content and display the pause screen 400. In an example, the content is paused and the pause screen 400 is displayed only if the RSSI of FHS packets received from the smartphone 302 is below the second threshold continuously over a second predetermined time period. The second predetermined time period may be the same as the first predetermined time period (for adding devices to the lookup table of FIG. 3B in the first place) or may be different. For example, it may be less than the first predetermined time period (e.g. 2.5 or 5 seconds) to reduce a delay in pausing when User 2 leaves the room (meaning User 2 is less likely to miss parts of the content before the content is paused).

The pause screen 400 includes a visual indicator 401 that the game has been paused (in the form of text “Game Paused”) and a visual indicator 402 explaining why the game has been paused. In this example, the visual indicator 402 is in the form of text “One or more users no longer detected”.

In another example, the games console 110 may obtain the name of each device included in the lookup table of FIG. 3B by, for example, paging each device (using its unique Bluetooth address identified in the lookup table), receiving a paging response including the device name and adding the name of each device to the lookup table. The name of a device is a name chosen by a user or manufacturer to assist a user in distinguishing between multiple discovered Bluetooth devices in a list. The names of devices 301, 302 and 302 may therefore be “User 1's Phone” for device 301, “User 2's Phone” for device 302 and “User 3's Watch” for device 302. The names are easier to identify and distinguish for humans than the unique Bluetooth address of each device included in the FHS packets during Bluetooth inquiry.

In an example, paging of each device only occurs for a predetermined period of time (e.g. 10 seconds) after that device is added to the lookup table in order to determine its name (and store and associate it with the device's unique Bluetooth address in the lookup table). Subsequently, no further paging is conducted and only inquiry signals are transmitted from the games console 110 to the devices 301, 302 and 303 (which, in response, transmit FHS packets on which the RSSI at the games console 110 is measureable, as described above). This helps reduce Bluetooth signalling overhead and device power consumption.

The pause screen 400 also includes a “Resume” virtual button 403. Selecting the virtual button 403 (e.g. using controller 140) allows a user to override the auto pause function and resume output of the content without the device 302 once again being detectable. This allows User 1 and User 2 to continue watching and/or playing the content if, for example, User 2 has left the room and does not intend to continue watching and/or playing the content. In response to selection of the virtual button 403, output of the content is resumed and the address of device 302 is removed from the lookup table to generate the updated lookup table exemplified in FIG. 5B. This allows the auto pause functionality to be continued based on the detection of devices 301 and 303 (belonging to User 1 and User 3) respectively. User convenience is therefore improved through the maintenance of the auto pausing functionality (so, for example, if User 1 or User 3 now leaves the room with device 301 or 303, respectively, the output of the content will be automatically paused again and the pause screen 400 will be displayed). At the same time, user control is maintained, allowing a user to override the auto pause functionality to account for one or more users no longer wishing to view the output content.

FIG. 5C exemplifies an automatic resumption of the content in response to User 2 returning to the room so the measured RSSI of FHS packet(s) transmitted by device 302 (e.g. in User 2's pocket) exceeds a third threshold. The third threshold may be the same as the first threshold or may be different (e.g. between the first and second thresholds). In response to the third threshold being exceeded, the games console 110 causes resumption screen 500 is displayed. In an example, resumption screen 500 is displayed only if the RSSI of FHS packets received from the device 302 is above the third threshold continuously over a third predetermined time period. The third predetermined time period may be the same as the first and/or second predetermined time periods or may be different. For example, it may be less than the first predetermined time period (e.g. 2.5 or 5 seconds) to reduce a delay in resumption of content when User 2 once again enters the room.

Resumption screen 500 once again includes the visual indicator 401. It also includes a visual indicator 501 indicating that all devices are now once again detected and that output of the content will therefore be resumed (and pausing of the content will end). In this case, the visual indicator 501 is the text “All devices detected-resuming in 5 seconds . . . “. The visual indicator 501 may be updatable in real time so that, as time elapses, the number of seconds indicated by the visual indicator is counted down (thus displaying “5 seconds” followed by “4 seconds” followed by “2 seconds and so on). After the time period indicated by the visual indicator has expired (the time period being, for example, 3, 5 or 10 seconds), output of the content is resumed. For example, display of the content 309 (exemplified in FIG. 4) is resumed. Resumption of the content thus occurs automatically in response to User 2 returning to the room (as determined based on detection of User 2's device 302) without any of the users needing to complete any manual operation. User convenience is therefore improved.

Resumption screen 500 also includes selectable virtual buttons 502 (“Continue pause”) and 503 (“Resume now”). These provide more control and flexibility to the users regarding pausing and resumption of the content.

Selecting the virtual button 502 cancels the automatic resumption and means pausing of the content is continued. For example, this may cause the games console 110 to implementing a conventional pausing function which requires explicit input from one of the users (e.g. via controller 140) to resume output of the content. This may be useful, for example, if User 2 returns to the room (meaning the resumption screen 500 is displayed) but is not yet ready for resumption of output of the content (for example, if User 2 is temporarily engaged with another activity such as talking on a telephone even though they have returned to the room).

Selecting the virtual button 503 causes immediate resumption of the content without the users having to wait for expiry of the time period indicated by the visual indicator 503. This may be useful, for example, when User 2 has returned to the room and all users are immediately ready for the content to be resumed. In this case, waiting 3, 5 or 10 seconds (for example) for output of the content to be resumed is unnecessary. Selecting the virtual button 503 thus means this wait is alleviated.

The present technique thus enables the pausing and resumption of content to be conducted automatically based on the devices in the vicinity of the games console 110 when output of the content is initiated. This improves user convenience. At the same time, due to the ability for users to select whether this functionality is activated or not (as exemplified in FIG. 3A) and to override the automatic pausing and resumption whenever necessary (as exemplified in FIGS. 5A and 5C), user flexibility and control is maintained.

In addition, due to the detection of devices being based on the RSSI of Bluetooth FHS packets received from those devices during Bluetooth inquiry signalling, the completion of a pairing process between each device 301, 302 and 303 and the games console 110 is not required for the described automatic pausing and resumption functionality to be implemented. Rather, each device can simply be in an inquiry scan state, which is a relatively low power consumption state allowing a Bluetooth device to be discovered by another Bluetooth device. Minimal setup is therefore required, thereby improving user convenience and allowing the system to be used seamlessly with different users (e.g. people living in a household or visitors). User privacy and security is also maintained, since no data needs to be exchanged between the games console 110 and each device 301, 302 and 303 other than the basic information (including unique Bluetooth address) transmitted in the FHS packets and, optionally, the Bluetooth name given to each device by its owner or manufacturer (obtained through a paging process performed only at the outset).

Although Bluetooth has been used as an example, it will be appreciated that the present technique is not limited to this. Rather, any suitable form of short-range wireless communication (e.g. using a radio frequency band of −2.4 to 2.5 GHZ) may be used if it enables the discovery of a set of devices (“discoverable” devices, e.g. device 301, 302 and/or 303) by another device (a “discovering” device, e.g. games console 110) in such a way that the discovered devices in the set can be distinguished from each other (e.g. since they have different respective addresses or identifiers) without a data connection between the discovered devices and the discovering device being established.

For example, Bluetooth Low Energy (BLE)® or Wi-Fi® technology may be used instead. For BLE, each discoverable device may periodically transmit a BLE beacon signal including a unique BLE identifier and for which an RSSI is measurable by a BLE transceiver (incorporated as part of data port(s) 60 of games console 110, for example).

For Wi-Fi, each discoverable device may enter a Wi-Fi “hotspot” mode and periodically transmit a Wi-Fi signal including a unique service set identifier (SSID) and for which an RSSI is measurable by a Wi-Fi by a Wi-Fi transceiver (incorporated as part of the data port(s) 60 of games console 110, for example).

Although, in the above-mentioned examples, the measured RSSI itself is compared against a threshold (e.g. a first threshold for a device being added to the lookup table, a second threshold for automatic content pausing to be executed and a third threshold for automatic content resumption to be executed), alternatively, or in addition, another parameter associated with the measured RSSI may be used. For example, for determining whether or not automatic pausing should be executed (as exemplified in FIG. 5A), it may be determined whether a magnitude of a rate of change of the RSSI of any of the devices in the lookup table exceeds a threshold.

For example, if it is determined that the RSSI of device 302 (belonging to User 2) falls by at least a first threshold amount (e.g. 30, 40 or 50 dBm) within a predetermined time period (e.g. 5 or 10 seconds), then it may be determined that device 302 has moved out of the room and that output of the content should therefore be paused. Similarly, if it is determined that the RSSI of device 302 increases by at least a second threshold amount (which may be the same as or different to the first threshold amount, e.g. 30, 40 or 50 dBm) within a predetermined time period (e.g. 5 or 10 seconds), then it may be determined that device 302 is once again in the room and that output of the content should therefore be resumed This may help distinguish normal, small, fluctuations in the detected RSSI associated with a particular device from a sudden reduction or increase in the detected RSSI when that device leaves or re-enters a room (in the pocket of a user, for example). Determination of when to pause and when to resume the output of content may therefore be carried out more accurately.

In the above examples, the second and third RSSI thresholds and/or the first and second threshold amounts for the magnitude of the rate of change of the RSSI are static absolute values (such as −80, −90 or −100 dBm for the second and/or third predetermined RSSI thresholds or 30, 40 or 50 dBm for the RSSI rate of change magnitude threshold). Alternatively, one or more of these thresholds may be dynamically determined on a device-by-device basis based on, for example, the initially measured RSSI of each device when it is first added to the lookup table (which may, in turn, be determined as the average measured RSSI over the first predetermined time period, for example).

For example, for a given device, each of these thresholds may be set based on 50% of that of the magnitude of the initially measured RSSI of a device. Thus, for a device with an initially measured RSSI of −60 dBm, for example, 50% of the magnitude of this is 30 dBm. The second and third thresholds may therefore be set as 60-30=−90 dBm and the first and second RSSI rate of change thresholds may be set as 30 dBm (e.g. so a drop in the detected RSSI of FHS packet(s) transmitted by that device of at least 30 dBm over, say, 5 or 10 seconds results in automatic pausing taking place). On the other hand, for a device with an initially measured RSSI of −40 dBm, 50% of the magnitude of this is 20 dBm. The second and third thresholds may therefore be set as 40-20=−60 dBm and the first and second RSSI rate of change thresholds may be set as 20 dBm (e.g. so a drop in the detected RSSI of FHS packet(s) transmitted by that device of at least 20 dBm over, say, 5 or 10 seconds results in automatic pausing taking place).

This allows the automatic pausing functionality to better take into account varying output signal strengths of different devices. For example, for an absolute drop of −20 dBm in a strongly detected signal (for example, a signal with a detected RSSI of −40 dBm), it may be desirable to pause the output of content, since such a drop is more significant in relative terms (indicating that a user is likely to have left the room with the device). On the other hand, for that same absolute drop in a weakly detected signal (for example, with a detected RSSI of −70 dBm), it may be not be necessary to pause the output of content, since such a drop is less significant in relative terms (and thus may have occurred due to, for example, a simple repositioning of the object in the room when all users are still in the room). This helps to improve the accuracy of the automatic pausing functionality.

In this example, the term “pausing output” of content means, for example, pausing playback of video content (so a still video frame is temporarily displayed) or pausing a video game (so progress of the video game is temporarily suspended and a pause menu or the like is displayed). Conversely, the term “resumption” or “resuming” of content means, for example, resuming playback of video content after it has been paused or resuming a video game (so a pause menu or the like is no longer shown and progress of the video game is continued). The “pausing” and “resumption” of content includes any audio included as part of the content (such as TV show, movie or video game dialogue, sounds effects or music). The present technique is therefore applicable to audio and/or visual content generally.

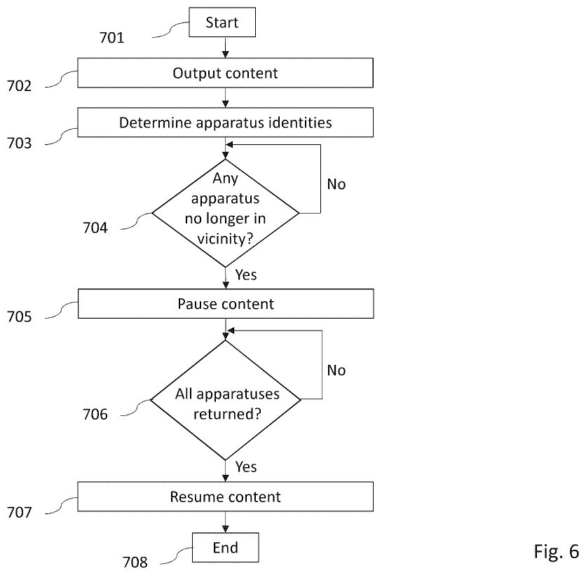

An example data processing method according to the present technique is shown in FIG. 6.

The method of FIG. 6 is a computer-implemented method carried out by circuitry of a data processing apparatus (e.g. the CPU 20 of games console 110). The method starts at step 701. At step 702, output of audio and/or visual content (e.g. a video or video game) is initiated.

At step 703, based on one or more first short-range wireless discovery signals received from each of one or more other apparatuses in a vicinity of the data processing apparatus when output of the content is initiated (e.g. Bluetooth FHS packets transmitted by each of devices 301, 302 and 303 in response to a Bluetooth inquiry signal transmitted by games console 110), an identity (e.g. Bluetooth address) of each of the one or more other apparatuses is determined.

At step 704, based on one or more second short-range wireless discovery signals received from each of the one or more other apparatuses (e.g. further Bluetooth FHS packets transmitted by each of devices 301, 302 and 303 in response to a Bluetooth inquiry signal transmitted by games console 110), it is determined whether any of the one or more other apparatuses are no longer in the vicinity of the data processing apparatus (e.g. based on the RSSI of the received FHS packets).

When any of the one or more other apparatuses are no longer in the vicinity of the data processing apparatus, the method proceeds to step 705, in which output of the content is paused. Alternatively, when all apparatuses are still in the vicinity of the data processing apparatus, step 704 is repeated.

At step 706, based on one or more third short-range wireless discovery signals received from each of the one or more other apparatuses (e.g. further Bluetooth FHS packets transmitted by each of devices 301, 302 and 303 in response to a Bluetooth inquiry signal transmitted by games console 110), it is determined whether all of the one or more other apparatuses are again in the vicinity of the data processing apparatus (e.g. based on the RSSI of the received FHS packets).

When all of the one or more other apparatuses are again in the vicinity of the data processing apparatus, the method proceeds to step 707, in which output of the content is resumed. The method then ends at step 708. Alternatively, when any of the one or more other apparatuses are still not in the vicinity of the data processing apparatus, step 706 is repeated.

Example(s) of the present technique are defined by the following numbered clauses:
1. A data processing apparatus comprising circuitry configured to: initiate output of audio and/or visual content; determine, based on one or more first short-range wireless discovery signals received from each of one or more other apparatuses in a vicinity of the data processing apparatus when output of the content is initiated, an identity of each of the one or more other apparatuses; and determine, based on one or more second short-range wireless discovery signals received from each of the one or more other apparatuses, whether any of the one or more other apparatuses are no longer in the vicinity of the data processing apparatus; and when any of the one or more other apparatuses are no longer in the vicinity of the data processing apparatus, pause output of the content.
2. A data processing apparatus according to clause 1, wherein the circuitry is configured to determine that each of the one or more other apparatuses is in the vicinity of the data processing apparatus when a measured signal strength of the one or more first short-range wireless discovery signals received from each of the one or more other apparatuses exceeds a first threshold for a first predetermined time period.
3. A data processing apparatus according to clause 3, wherein the first predetermined time period begins when the output of the content is initiated.
4. A data processing apparatus according to clause 2 or 3, wherein the circuitry is configured to determine that one of the one or more other apparatuses is no longer in the vicinity of the data processing apparatus when a measured signal strength of the one or more second short-range wireless discovery signals received from the one of the one or more other apparatuses falls below a second threshold for a second predetermined time period.
5. A data processing apparatus according to clause 2 or 3, wherein the circuitry is configured to determine that one of the one or more other apparatuses is no longer in the vicinity of the data processing apparatus when a measured signal strength of the one or more second short-range wireless discovery signals received from the one of the one or more other apparatuses falls with a rate of change in magnitude of at least a first threshold.
6. A data processing apparatus according to any preceding clause, wherein the circuitry is configured, when output of the content is paused, to: determine, based on one or more third short-range wireless discovery signals received from each of the one or more other apparatuses, whether all of the one or more other apparatuses are again in the vicinity of the data processing apparatus; and when all of the one or more other apparatuses are again in the vicinity of the data processing apparatus, resume output of the content.
7. A data processing apparatus according to clause 6, wherein the circuitry is configured to determine that one of the one or more other apparatuses which was no longer in the vicinity of the data processing apparatus is again in the vicinity of the data processing apparatus when a measured signal strength of the one or more third short-range wireless discovery signals received from the one of the one or more other apparatuses exceeds a third threshold for a third predetermined time period.
8. A data processing apparatus according to clause 6, wherein the circuitry is configured to determine that one of the one or more other apparatuses which was no longer in the vicinity of the data processing apparatus is again in the vicinity of the data processing apparatus when a measured signal strength of the one or more third short-range wireless discovery signals received from the one of the one or more other apparatuses increases with a rate of change in magnitude of at least a second threshold.
9. A data processing apparatus according to any preceding clause, wherein the circuitry is configured to: store the identity of each of the one or more other apparatuses from which the one or more first short-range wireless discovery signals are received; while output of the content is paused, receive an input from a user instructing output of the content to be resumed; in response to the received input, resume output of the content and remove the identity of any of the one or more other apparatuses determined to no longer be in the vicinity of the data processing apparatus at a time when the input from the user is received.
10. A data processing apparatus according to any preceding clause, wherein: the first, second and third short-range wireless discovery signals are Bluetooth® Frequency Hopping Synchronization, FHS, packets received in response to Bluetooth inquiry signals transmitted by the circuitry.
11. A data processing method comprising: initiating output of audio and/or visual content; determining, based on one or more first short-range wireless discovery signals received from each of one or more other apparatuses in a vicinity of the data processing apparatus when output of the content is initiated, an identity of each of the one or more other apparatuses; and determining, based on one or more second short-range wireless discovery signals received from each of the one or more other apparatuses, whether any of the one or more other apparatuses are no longer in the vicinity of the data processing apparatus; and when any of the one or more other apparatuses are no longer in the vicinity of the data processing apparatus, pausing output of the content.
12. A program for controlling a computer to perform a method according to clause 11.
13. A storage medium storing a program according to clause 12.

Numerous modifications and variations of the present disclosure are possible in light of the above teachings. It is therefore to be understood that, within the scope of the claims, the disclosure may be practiced otherwise than as specifically described herein.

In so far as embodiments of the disclosure have been described as being implemented, at least in part, by one or more software-controlled information processing apparatuses, it will be appreciated that a machine-readable medium (in particular, a non-transitory machine-readable medium) carrying such software, such as an optical disk, a magnetic disk, semiconductor memory or the like, is also considered to represent an embodiment of the present disclosure. In particular, the present disclosure should be understood to include a non-transitory storage medium comprising code components which cause a computer to perform any of the disclosed method(s).

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more computer processors (e.g. data processors and/or digital signal processors). The elements and components of any embodiment may be physically, functionally and logically implemented in any suitable way. Indeed, the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to these embodiments. Additionally, although a feature may appear to be described in connection with particular embodiments, one skilled in the art would recognize that various features of the described embodiments may be combined in any manner suitable to implement the present disclosure.

1. A data processing apparatus comprising circuitry configured to:
initiate output of audio and/or visual content;
determine, based on one or more first short-range wireless discovery signals received from each of one or more other apparatuses in a vicinity of the data processing apparatus when output of the content is initiated, an identity of each of the one or more other apparatuses; and
determine, based on one or more second short-range wireless discovery signals received from each of the one or more other apparatuses, whether any of the one or more other apparatuses are no longer in the vicinity of the data processing apparatus; and
when any of the one or more other apparatuses are no longer in the vicinity of the data processing apparatus, pause output of the content.

2. A data processing apparatus according to claim 1, wherein the circuitry is configured to determine that each of the one or more other apparatuses is in the vicinity of the data processing apparatus when a measured signal strength of the one or more first short-range wireless discovery signals received from each of the one or more other apparatuses exceeds a first threshold for a first predetermined time period.

3. A data processing apparatus according to claim 3, wherein the first predetermined time period begins when the output of the content is initiated.

4. A data processing apparatus according to claim 2, wherein the circuitry is configured to determine that one of the one or more other apparatuses is no longer in the vicinity of the data processing apparatus when a measured signal strength of the one or more second short-range wireless discovery signals received from the one of the one or more other apparatuses falls below a second threshold for a second predetermined time period.

5. A data processing apparatus according to claim 2, wherein the circuitry is configured to determine that one of the one or more other apparatuses is no longer in the vicinity of the data processing apparatus when a measured signal strength of the one or more second short-range wireless discovery signals received from the one of the one or more other apparatuses falls with a rate of change in magnitude of at least a first threshold.

6. A data processing apparatus according to claim 1, wherein the circuitry is configured, when output of the content is paused, to:
determine, based on one or more third short-range wireless discovery signals received from each of the one or more other apparatuses, whether all of the one or more other apparatuses are again in the vicinity of the data processing apparatus; and
when all of the one or more other apparatuses are again in the vicinity of the data processing apparatus, resume output of the content.

7. A data processing apparatus according to claim 6, wherein the circuitry is configured to determine that one of the one or more other apparatuses which was no longer in the vicinity of the data processing apparatus is again in the vicinity of the data processing apparatus when a measured signal strength of the one or more third short-range wireless discovery signals received from the one of the one or more other apparatuses exceeds a third threshold for a third predetermined time period.

8. A data processing apparatus according to claim 6, wherein the circuitry is configured to determine that one of the one or more other apparatuses which was no longer in the vicinity of the data processing apparatus is again in the vicinity of the data processing apparatus when a measured signal strength of the one or more third short-range wireless discovery signals received from the one of the one or more other apparatuses increases with a rate of change in magnitude of at least a second threshold.

9. A data processing apparatus according to claim 1, wherein the circuitry is configured to:
store the identity of each of the one or more other apparatuses from which the one or more first short-range wireless discovery signals are received;
while output of the content is paused, receive an input from a user instructing output of the content to be resumed;
in response to the received input, resume output of the content and remove the identity of any of the one or more other apparatuses determined to no longer be in the vicinity of the data processing apparatus at a time when the input from the user is received.

10. A data processing apparatus according to claim 1, wherein: the first, second and third short-range wireless discovery signals are Bluetooth® Frequency Hopping Synchronization, FHS, packets received in response to Bluetooth inquiry signals transmitted by the circuitry.

11. A data processing method comprising:
initiating output of audio and/or visual content;
determining, based on one or more first short-range wireless discovery signals received from each of one or more other apparatuses in a vicinity of the data processing apparatus when output of the content is initiated, an identity of each of the one or more other apparatuses; and
determining, based on one or more second short-range wireless discovery signals received from each of the one or more other apparatuses, whether any of the one or more other apparatuses are no longer in the vicinity of the data processing apparatus; and
when any of the one or more other apparatuses are no longer in the vicinity of the data processing apparatus, pausing output of the content.

12. (canceled)

13. A non-transitory computer-readable storage medium storing a program for controlling a computer to perform a data processing method comprising:
initiating output of audio and/or visual content;
determining, based on one or more first short-range wireless discovery signals received from each of one or more other apparatuses in a vicinity of the data processing apparatus when output of the content is initiated, an identity of each of the one or more other apparatuses; and
determining, based on one or more second short-range wireless discovery signals received from each of the one or more other apparatuses, whether any of the one or more other apparatuses are no longer in the vicinity of the data processing apparatus; and
when any of the one or more other apparatuses are no longer in the vicinity of the data processing apparatus, pausing output of the content.
